(19) United States
(12) Patent Application Publication
(10) Pub. No.: US 2013/0028783 A1
(43) Pub. Date: Jan. 31, 2013

(54) SOLDER ALLOY, SOLDERING METHOD AND COMPONENT

(71) Applicants: Michael Ott, Muelheim an der Ruhr (DE); Sebastian Piegert, Berlin (DE)

(72) Inventors: Michael Ott, Muelheim an der Ruhr (DE); Sebastian Piegert, Berlin (DE)

(21) Appl. No.: 13/639,113

(22) PCT Filed: Apr. 12, 2010
(86) PCT No.: PCT/EP10/54754

§ 371 Date: Oct. 3, 2012

(51) Int. Cl. B23K 35/24; C22C 19/05; C22C 30/00

(52) U.S. Cl. 420/445; 420/588

(57) ABSTRACT

A solder alloy including a base material, a solder, and an additive is provided. The solder alloy has the following formula:

(1−x−y)*base material+x*solder+y*additive,
where 0.2≦x≦0.8 and
0≦y<0.8 and also (y<1−x).
   The base material includes chromium, nickel, aluminum, and tungsten. The solder includes chromium, cobalt, aluminum, tungsten, germanium and/or gallium, and nickel. The additive may include boron, zirconium, and carbon.

### CROSS REFERENCE TO RELATED APPLICATIONS

This application is the US National Stage of International Application No. PCT/EP2010/054754, filed Apr. 12, 2010 and claims the benefit thereof. All of the applications are incorporated by reference herein in their entirety.

### FIELD OF INVENTION

The invention relates to a solder alloy, to a soldering process and to a component containing solder.

### BACKGROUND OF INVENTION

It is sometimes necessary to repair components after they have been produced, for example after casting or after they have been used and cracks have formed.

There are various repair processes for this purpose, for example the welding process; in this process, however, it is additionally necessary to melt a substrate material of the component, and this may result in damage particularly to cast and directionally solidified components and in the evaporation of constituents of the substrate material.

A soldering process is carried out at temperatures which are lower than the temperature for the welding process and therefore lower than the melting temperature of the substrate material.

Nevertheless, the solder should have high strength in order that the crack filled with solder or the depression does not weaken the entire component at the high operating temperatures.

### SUMMARY OF INVENTION

It is therefore an object of the invention to provide a solder alloy which solves the problem mentioned above.

The object is achieved by a solder consisting of a solder alloy as claimed in the claims, a process as claimed in the claims and a component as claimed in the claims.

The solder alloy consists of:

(1−x−y)*base material+x*solder+y*additive,

where 0.2≦x≦0.8 and
0≦y<0.8 and also (y<1−x),
wherein the base material comprises:
20 wt %-35 wt % chromium (Cr), in particular 22 wt % to 27 wt %,
more particularly 25 wt %, 1 wt %-15 wt % nickel (Ni), in particular 10 wt %,
0.1 wt %-6 wt % aluminum (Al), in particular 0.1 wt %-3 wt %,
more particularly 0.1 wt %,
3 wt %-12 wt % tungsten (W), in particular 6 wt % to 10 wt %,
more particularly 8 wt %, optionally
0.1 wt %-1 wt % titanium (Ti), in particular 0.1 wt %,
0.1 wt %-1 wt % molybdenum (Mo), in particular 0.1 wt %,
0.1 wt %-6 wt % tantalum (Ta), in particular 4 wt %, and
cobalt (Co), and
wherein the solder comprises:
0.1 wt %-10 wt % chromium (Cr), in particular 4 wt %-8 wt %,
0.1 wt %-10 wt % cobalt (Co), in particular 4 wt %-8 wt %,
0.1 wt %-6 wt % aluminum (Al), in particular 1.5 wt %,
0.1 wt %-6 wt % tungsten (W), in particular 3 wt %, and
germanium (Ge) and/or gallium (Ga),
in particular 18 wt % to 30 wt %,
more particularly 27 wt %,
nickel,
wherein the additive comprises:
0 wt %-0.010 wt % boron (B), in particular 0.001 wt %<B<0.010 wt %,
0 wt %-0.6 wt % zirconium (Zr), in particular ≦0.05 wt %,
0 wt %-0.7 wt % carbon (C), in particular 0.01 wt %<Zr≦0.25 wt %.

Further advantageous developments of the alloy are:

the base material uses only one, two or three elements selected from the group consisting of titanium (Ti), molybdenum (Mo) and tantalum (Ta),
the base material is cobalt-based,
in particular the base material comprises cobalt as remainder, the solder is nickel-based,
in particular the solder comprises nickel as remainder,
the solder alloy is cobalt-based,
in particular the solder alloy comprises cobalt as remainder, it contains no deliberate
addition of boron (B),
in particular <20 ppm,
it contains no silicon (Si),
it comprises no zirconium (Zr),
it comprises no hafnium (Hf),
it comprises no niobium (Nb),
it comprises no carbon (C),
it contains no titanium,
it contains no molybdenum (Mo),
it contains no tantalum (Ta),
it has the greatest proportion by weight of cobalt (Co),
it comprises gallium (Ga) and no germanium (Ge),
it comprises germanium (Ge) and no gallium (Ga),
it comprises gallium (Ga) and germanium (Ge),
it comprises at least 0.01 wt % zirconium (Zr),
in particular at least 0.12 wt %,
it comprises at most 0.04 wt % zirconium (Zr),
in particular at most 0.5 wt %,
it comprises carbon (C),
at least 0.05 wt %, in particular at least 0.13 wt %,
it comprises at most 0.55 wt % carbon (C),
in particular at most 0.2 wt % carbon (C),
0.3≦x≦0.5,

y=0,

0.2≦Y,

in particular 0.3≦y≦0.5,
it contains no manganese (Mn),
it contains at least 1.5% tungsten (W),
in particular 1.6 wt %,
the tungsten content is at most 6.4 wt %,
in particular is at most 6.0 wt %,
it contains at least 0.6 wt % tantalum (Ta),
in particular at least 0.8 wt %,
it comprises at most 3.2 wt % tantalum,
in particular at most 2.5 wt %,
the gallium (Ga) or germanium (Ge) content is ≧1.5 wt %,
in particular in which the gallium or germanium content is ≧3 wt %,
the gallium (Ga) or germanium (Ge) content is ≧6 wt %,
the gallium (Ga) or germanium (Ge) content is ≦28 wt %,
in particular in which the gallium or germanium content is ≦24 wt %,

it contains at least 4.8 wt % chromium (Cr),

in particular at least 5.8 wt %,

it contains at most 24 wt % chromium (Cr),

in particular at most 20% chromium,

it contains at least 0.05 wt % aluminum (Al),

it contains at most 0.2 wt % aluminum (Al),

it comprises at least 0.06 wt % titanium (Ti),

it comprises at most 0.24 wt % titanium (Ti),

it comprises no aluminum (Al),

the solder alloy consists of nickel, chromium, cobalt, aluminum, tungsten and germanium, or

the solder alloy consists of nickel, chromium, germanium, cobalt, tungsten and tantalum, or

the solder alloy consists of nickel, chromium, cobalt, aluminum, tungsten, tantalum and germanium, or

the solder alloy consists of nickel, germanium, cobalt, chromium, aluminum, titanium, tungsten and tantalum, or

it consists of nickel, germanium, cobalt, chromium, aluminum, titanium, tungsten and tantalum, or

the process includes that the solder alloy is solidified in polycrystalline form (CC), in particular in CC components.

Further advantageous developments of the process are: —the solder alloy is directionally solidified,

the solder alloy is solidified isothermally.

The component contains a solder alloy as per the features indicated above and is preferably directionally solidified.

The component is advantageously formed respectively by the following measures:

the substrate is directionally solidified,

the substrate is not directionally solidified,

the chromium content of the solder alloy corresponds to the chromium content of the substrate of the component,

the cobalt content of the solder alloy corresponds to the cobalt content of the substrate of the component,

the aluminum content of the solder alloy corresponds to the aluminum content of the substrate of the component,
the titanium content of the solder alloy corresponds to the titanium content of the substrate of the component, —the titanium content of the solder alloy is reduced compared to the titanium content of the substrate of the component, if higher contents of germanium are used,

in which the molybdenum content of the solder alloy is ≦2 wt %, in particular ≦1 wt %,

if tungsten is present in the solder alloy

in a content greater than the degree of impurity,

in which the tantalum content of the solder alloy is ≦4 wt %.

The dependent claims list further advantageous measures which can advantageously be combined with one another in any desired way.

### BRIEF DESCRIPTION OF THE DRAWINGS

In the drawings:

FIG. 1 shows a cross-sectional view of a component after treatment with the solder according to the invention,

FIG. 2 shows a perspective view of a turbine blade or vane,

FIG. 3 shows a perspective view of a combustion chamber,

FIG. 4 shows a gas turbine, and

FIG. 5 shows a list of superalloys.

The figures and the description represent merely an exemplary embodiment of the invention.

### DETAILED DESCRIPTION OF INVENTION

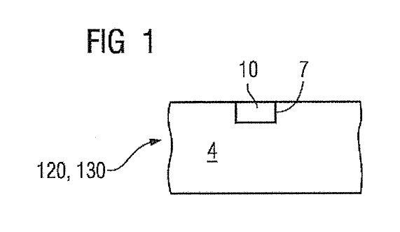

FIG. 1 shows a component 1 which is treated with a solder 10 consisting of a solder alloy according to the invention.

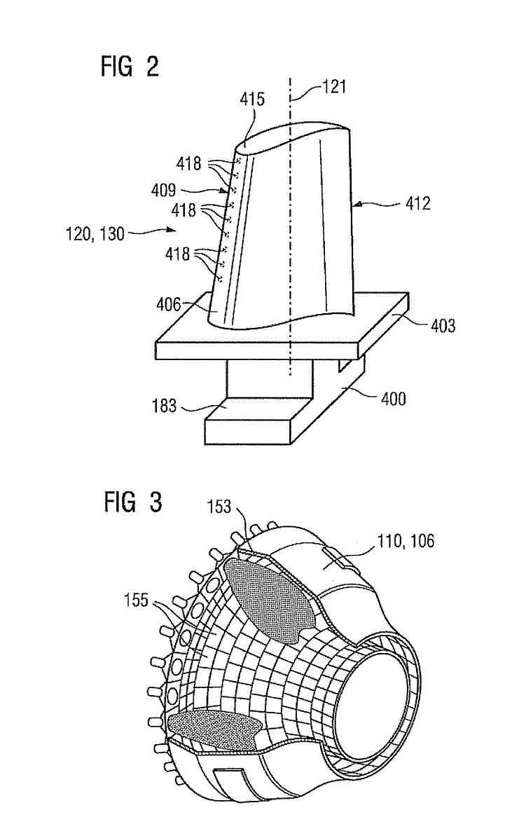

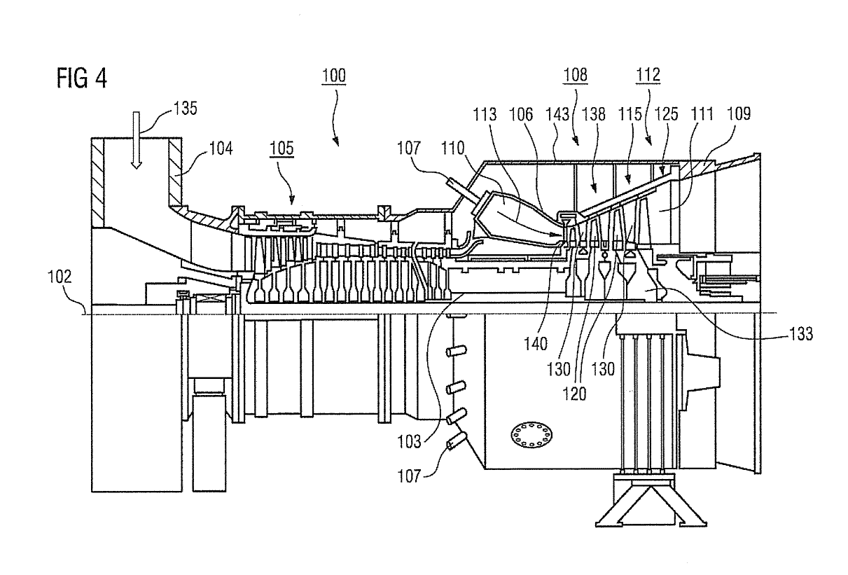

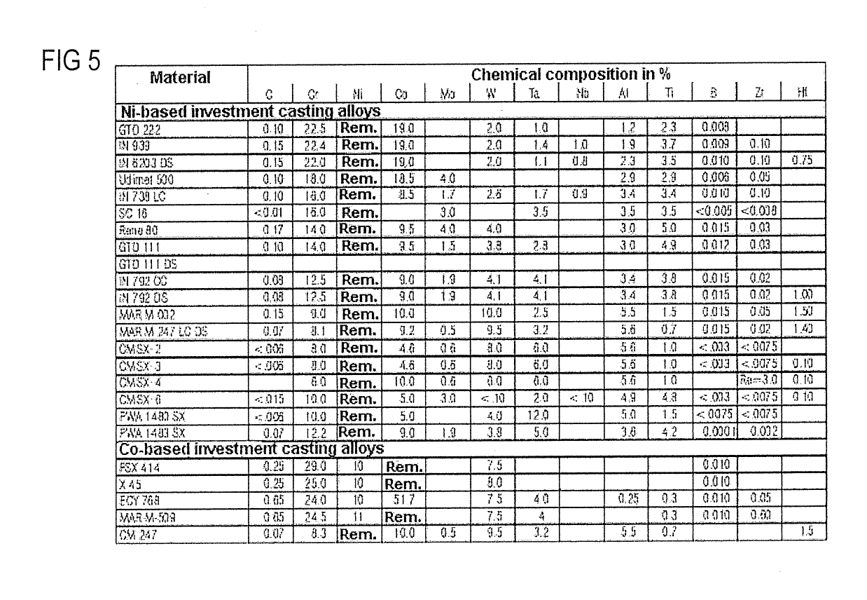

The component 1 comprises a substrate 4 which, particularly in the case of components for high temperature applications, in particular in the case of turbine blades or vanes 120, 130 (FIG. 2) or combustion chamber elements 155 (FIG. 3) for steam or gas turbines 100 (FIG. 4), consists of a nickel-based or cobalt-based superalloy (FIG. 5).

The solder material 10 can preferably be used for all the alloys according to FIG. 5.

These may preferably be the known materials PWA 1483, PWA 1484 or Rene N5.

The solder material 10 is also used in blades or vanes for aircraft.

A crack 7 or a depression 7 which is to be filled by soldering is present in the substrate 4. The cracks 7 or depressions 7 preferably have a width of about 200 μm and may have a depth of up to 5 mm.

In this case, the solder 10 consisting of a solder alloy is applied into or close to the depression 7, and the solder material 10 is melted by heat treatment (+T) below a melting temperature of the substrate 4 and completely fills the depression 7.

The solder alloy comprises a base material, a solder and an additive, and preferably consists of base material, solder and additive:

with (1−x−y)*base material+x*solder+y*additive,

where 0.2≦x≦0.8 and
0≦y<0.8 and also (y<1−x),
wherein the base material comprises:
20 wt %-35 wt % chromium (Cr), in particular 25 wt %,
1 wt %-15 wt % nickel (Ni), in particular 10 wt %,
0.1 wt %-6 wt % aluminum (Al), in particular 0.1 wt %-3 wt %,
more particularly 0.1 wt %,
3 wt %-12 wt % tungsten (W), in particular 8 wt %, and optionally
0.1 wt %-1 wt % titanium (Ti), in particular 0.1 wt %,
0.1 wt %-1 wt % molybdenum (Mo), in particular 0.1 wt %,
0.1 wt %-6 wt % tantalum (Ta), in particular 4 wt %, and
cobalt (Co), and
wherein the solder comprises:
0.1 wt %-10 wt % chromium (Cr), in particular 4 wt %-8 wt %,
0.1 wt %-10 wt % cobalt (Co), in particular 4 wt %-8 wt %,
0.1 wt %-6 wt % aluminum (Al), in particular 1.5 wt %,
0.1 wt %-6 wt % tungsten (W), in particular 3 wt %, and
germanium (Ge) and/or gallium (Ga),
in particular 18 wt % to 30 wt %,
more particularly 27 wt %,
nickel,
wherein the additive comprises: 0 wt %-0.010 wt % boron (B), in particular <0.010 wt %,
0 wt %-0.6 wt % zirconium (Zr), in particular ≦0.05 wt %,
0 wt %-0.7 wt % carbon (C), in particular ≦0.25 wt %.

The solder alloy therefore represents a physical mixture of two (base material, solder) or three (+additive) powders.

Only one, two or three elements from the group consisting of titanium, molybdenum and tantalum may be used for the base material.

The addition of germanium preferably dispenses with the addition of boron (B).

The same likewise preferably applies for the melting point reducer silicon (Si).

For the addition of the melting point reducer, it is possible for the solder alloy to comprise: gallium (Ga) and no germanium (Ge) or germanium (Ge) and no gallium (Ga) or gallium (Ga) and germanium (Ge).

The base material is cobalt-based.

The solder is nickel-based.

The solder alloy is cobalt-based and is preferably suitable for cobalt-based superalloys.

The solder alloy preferably comprises no zirconium (Zr), no hafnium (Hf), no niobium (Nb), manganese (Mn) or no carbon (C).

Particularly good solder alloys are obtained where

0.3≦x≦0.5,
y=0 or

### 0.2≦Y,

in particular 0.3≦y≦0.5.

Advantageous values for carbon (C), zirconium (Zr), aluminum (Al), titanium (Ti), tungsten (W), tantalum (Ta), chromium (Cr), cobalt (Co), germanium (Ge) and gallium (Ga) are listed in the dependent claims.

Advantageous lists of conclusive alloy compositions are given in the dependent claims.

The addition of rhenium can also preferably be dispensed with.

The addition or the presence of silicon and/or carbon is preferably avoided since they form brittle phases in the solder.

It is similarly preferable to avoid the addition or the presence of iron and/or manganese since these elements form low-melting phases or non-oxidizing phases.

The solder material 10 may be joined to the substrate 4 of the component 1, 120, 130, 155 in an isothermal process or a temperature gradient process. A gradient process is preferably suitable when the substrate 4 has a directional structure, for example an SX or DS structure, such that the solder material 10 then also has a directional structure. However, a directionally solidified structure in the solder may also be provided in an isothermal process.

Equally, the component 1, 120, 130 does not need to have a directionally solidified structure (but rather a CC structure).

The solders in CC substrates of components 1, 120, 130 may likewise be soldered and solidified in a CC structure, the solders then being solidified in polycrystalline form (CC).

The following solders are of particular interest especially for the polycrystalline solidification of the solders:

During the melting (isothermal process or gradient process), use is preferably made of an inert gas, in particular argon, which reduces the vaporization of chromium from the substrate 4 at the high temperatures, or a reducing gas (argon/hydrogen) is used.

The solder material 10 may also be applied to a large area of a surface of a component 1, 120, 130, 155 in order to thicken the substrate 4, in particular in the case of hollow components. The solder material 10 is preferably used to fill cracks 7 or depressions 7.

FIG. 2 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, in particular the superalloys according to FIG. 5, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer.

Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

FIG. 3 shows a combustion chamber 110 of a gas turbine. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1.

It is also possible for a, for example, ceramic thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from heat shield elements 155 (e.g. by sand-blasting). Then, the corrosion and/or oxidation layers and products are removed. If appropriate, cracks in the heat shield element 155 are also repaired. This is followed by recoating of the heat shield elements 155, after which the heat shield elements 155 can be reused.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

FIG. 4 shows, by way of example, a partial longitudinal section through a gas turbine 100.

In the interior, the gas turbine 100 has a rotor 103 with a shaft 101 which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The blades or vanes 120, 130 may also have coatings which protect against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element or hafnium). Alloys of this type are known from EP 0 486 489 B1, EP 0 786 017 B1, EP 0 412 397 B1 or EP 1 306 454 A1.

A thermal barrier coating, consisting for example of ZrO₂, Y₂O₃—ZrO₂, i.e. unstabilized, partially stabilized or fully stabilized by yttrium oxide and/or calcium oxide and/or magnesium oxide, may also be present on the MCrAlX.

Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

1-60. (canceled)

61. A solder alloy, consisting of:
(1−x−y)*base material+x*solder+y*additive,
where 0.2≦x≦0.8 and
0≦y<0.8 and also (y<1−x),
wherein the base material comprises:
20 wt %-35 wt % chromium,
1 wt %-15 wt % nickel,
0.1 wt %-6 wt % aluminum, and
3 wt %-12 wt % tungsten,
wherein the solder comprises:
0.1 wt %-10 wt % chromium,
0.1 wt %-10 wt % cobalt,
0.1 wt %-6 wt % aluminum,
0.1 wt %-6 wt % tungsten,
germanium and/or gallium, and
at least 1 wt % nickel,
wherein the additive comprises:
0 wt %-0.010 wt % boron,
0 wt %-0.6 wt % zirconium, and
0 wt %-0.7 wt % carbon.

62. The solder alloy as claimed in claim 61, wherein the base material further comprises only one element selected from the group consisting of titanium, molybdenum and tantalum.

63. The solder alloy as claimed in claim 61, wherein the base material further comprises at least two elements selected from the group consisting of titanium, molybdenum and tantalum.

64. The solder alloy as claimed in claim 61, wherein the base material further comprises titanium, molybdenum and tantalum.

65. The solder alloy as claimed in claim 61, wherein the base material is cobalt-based.

66. The solder alloy as claimed in claim 61, wherein the solder comprises nickel as remainder.

67. The solder alloy as claimed in claim 61, wherein the solder alloy comprises cobalt as remainder.

68. The solder alloy as claimed in claim 61, wherein cobalt has the greatest proportion by weight.

69. The solder alloy as claimed in claim 61, wherein the additive comprises at least 0.01 wt % zirconium.

70. The solder alloy as claimed in claim 61, wherein the additive comprises at most 0.04 wt % zirconium.

71. The solder alloy as claimed in claim 61, wherein the additive comprises at least 0.05 wt % carbon.

72. The solder alloy as claimed in claim 61, wherein the additive comprises at most 0.55 wt % carbon.

73. The solder alloy as claimed in claim 61, where 0.3≦x≦0.5.

74. The solder alloy as claimed in claim 61, where y=0.

75. The solder alloy as claimed in claim 61, wherein 0.2≦y.

76. The solder alloy as claimed in claim 61, wherein the solder comprises at least 1.5 wt % tungsten.

77. The solder alloy as claimed in claim 61, wherein the solder comprises at most 6.4 wt % tungsten.

78. The solder alloy as claimed in claim 61, wherein the solder further comprises at least 0.6 wt % tantalum.

79. The solder alloy as claimed in claim 61, wherein the solder further comprises at most 3.2 wt % tantalum.

80. The solder alloy as claimed in claim 61, wherein the gallium or germanium content is ≧1.5 wt %.
